(19) United States
(12) Patent Application Publication
(10) Pub. No.: US 2023/0169697 A1
(43) Pub. Date: Jun. 1, 2023

(54) A COMPUTER SOFTWARE MODULE ARRANGEMENT, A CIRCUITRY ARRANGEMENT, AN ARRANGEMENT AND A METHOD FOR PROVIDING A VIRTUAL DISPLAY

(71) Applicant: Telefonaktiebolaget LM Ericsson (publ), Stockholm (SE)

(72) Inventors: Fredrik DAHLGREN, Lund (SE); Alexander HUNT, Tygelsjö (SE); Andreas KRISTENSSON, Södra Sandby (SE)

(73) Assignee: Telefonaktiebolaget LM Ericsson (publ), Stockholm (SE)

(21) Appl. No.: 17/927,612

(22) PCT Filed: May 25, 2020
(86) PCT No.: PCT/EP2020/064400

§ 371 Date: Nov. 23, 2022

(51) Int. Cl. G06T 11/00

(52) U.S. Cl. CPC G06T 11/00

(57) ABSTRACT

A virtual display arrangement (100) comprising an optical device (112) and a controller (101) configured to: a) detect (510) an optical pattern (210) through the optical device (210), the optical pattern (210) being associated with a virtual display (211) and the optical pattern (210) being arranged on an arbitrary surface (205); b) extract (520) information regarding the associated virtual display (211); c) set up (540) the virtual display (211) to correspond to an area (212) of a display (110) according to the extracted information associated with the optical pattern (210); d) retrieve (550) virtual content; and to e) present the virtual content in the area (212) of the display (110) corresponding to the virtual display (211).

### TECHNICAL FIELD

The present invention relates to an arrangement, an arrangement comprising computer software modules, an arrangement comprising circuits, a device and a method for providing for providing a virtual display, and in particular to an arrangement, an arrangement comprising computer software modules, an arrangement comprising circuits, a device and a method for providing for providing a virtual display in a flexible and easy to implement manner.

### BACKGROUND

Displays are used for providing visual information or content. Displays may be either physical or virtual. Physical displays may be implemented as self-projecting displays that are arranged to display the content by themselves, or they may be implemented as projected displays, where a projector displays the content on a reflective surface, such as a screen. In both cases, the display provides the visual content to all who can see the display.

Virtual displays, in the context of this application, are arranged to display computer or otherwise generated visual content. Virtual displays can be generated inside of head-mounted displays (HMD), which can be either in the form of virtual reality (VR) headsets or augmented reality or mixed reality headsets (AR/MR). In a VR headset, only the generated display is shown. There are variants of VR headsets with video see-through (VST). In VST the physical world is displayed to the user through a camera system. In an AR/MR headset, the physical world is shown as with normal glasses, and virtual content is overlaid the physical world. AR and MR are normally called optical see-through (OST) technology. By looking at a white wall, for example, a VR VST or AR/MR OST headset might show a virtual display as if there was a physical display, even if that virtual display is not available in real life.

The patent application published as US2018043259A1 discloses one example where virtual data is projected onto a surface as it discloses a computer-implemented method and system to deliver enhanced augmented reality gameplay experience for Trading Card Games. The computer-implemented method includes setting up a gaming session with a plurality of Gamers through a user interface. The computer-implemented method includes scanning one or more relevant cards and identifying a Game Component represented by the relevant cards. The computer-implemented method includes retrieving a pre-defined sequence of animated movements of a 3D model of the Game Component from a database by the game server. Further, the computer-implemented method includes superimposing the sequence of animated movements onto the image of the trading card as captured by the camera of the gaming device, thereby giving the effect of the animated 3D model augmenting the real image of the static trading card so that the Game Component appears to be alive. Furthermore, the computer-implemented method includes capturing one or more actions taken on the Game Components by the Gamer by a plurality of Input Parameters. Moreover, the computer-implemented method includes detecting information on the actions captured and subsequently sending the information to the Gaming Server through the data network. The computer-implemented method includes generating Outcome Parameters by logically matching the one or more actions taken with the cards in play against one or more actions and cards in play by the opposing Gamer. The computer-implemented method also includes superimposing the actions of the Outcome Parameters thereby giving the effect of the animated 3D model augmenting the real image of the static trading card to display the consequence of the Gamers one or more actions. The computer-implemented method includes completing the gaming session until the end is reached, the end is defined by the rules of the TCGs being played. However in that patent application data is projected onto a playing card irrespective of the orientation of the playing card an only the card's associated information is displayed. The playing card is thus not a virtual display as discussed herein.

The inventors have realized a problem that exist in contemporary virtual displays, namely that it is difficult to determine which surface the user is looking at and whether the surface is suitable for displaying content.

As the inventors have realized, there is thus a need for a device and a method for providing a manner of detecting objects that does not require vast processing resources nor an increase in object detection model complexity, while still allowing for a higher accuracy of object detection.

### SUMMARY

An object of the present teachings is to overcome or at least reduce or mitigate the problems discussed in the background section.

According to one aspect a virtual display arrangement 100 comprising an optical device and a controller configured to: a) detect an optical pattern 210 through the optical device, the optical pattern 210 being associated with a virtual display and the optical pattern 210 being arranged on an arbitrary surface; b) extract information regarding the associated virtual display; c) set up the virtual display to correspond to an area of a display according to the extracted information associated with the optical pattern; d) retrieve virtual content; and to e) present the virtual content in the area of the display corresponding to the virtual display.

A virtual display as understood herein is a surface (identified through the optical pattern) to which virtual (or augmented) data or content is projected onto. The virtual content is projected as if the virtual display is a real, physical display, i.e. the projection of the data may be skewed according to a viewing angle to the display. Also, as any real, physical display, the virtual display is of a fixed size and may display any content. It is thus different from an object that is recognized and onto which virtual data regarding the detected object is projected.

Furthermore, as discussed in more detail below, the surface that is be used may be any type or kind of surface, and the surface may not be associated with or related to the content being display. The surface is thus an arbitrary surface.

The solution may be implemented as a software solution, a hardware solution or a mix of software and hardware components.

In one embodiment the controller is further configured to perform security checks by f) determining if the optical pattern 210 is associated with a virtual display content provider (VDCP) and g) determining if the virtual display content provider (VDCP) is trusted.

In one embodiment the controller is further configured to determine if the virtual display arrangement 100 is directed at the virtual display, and if not adapt the retrieval of the virtual content.

In one embodiment the virtual content is dependent on a user of the virtual display arrangement.

In one embodiment the virtual content is dependent on a context.

In one embodiment the optical pattern 210 is applied at least partially in the visible spectra.

In one embodiment the optical pattern 210 is applied at least partially in the non-visible spectra.

In one embodiment the optical pattern 210 is applied to a surface through paint.

In one embodiment the optical pattern 210 is applied to a surface through a sticker.

In one embodiment the optical pattern 210 is applied to a surface through a projection.

In one embodiment the surface that the optical pattern 210 is applied to is a wall.

In one embodiment the surface that the optical pattern 210 is applied to is a piece of garment.

In one embodiment the surface that the optical pattern 210 is applied to is an accessory.

In one embodiment the optical pattern 210 is associated with a size and a location of the virtual display.

In one embodiment the optical pattern 210 is associated with an angle of the virtual display.

In one embodiment the virtual content comprises visual content.

In one embodiment the optical pattern 210 is associated with a brand and/or company.

In one embodiment the controller is configured to b) extract information regarding the associated virtual display from a remote server.

In one embodiment the virtual display arrangement 100 further comprises a memory arranged to store a local server (VDCP), wherein the controller is configured to b) extract information regarding the associated virtual display from the local server in the memory.

In one embodiment the virtual display arrangement 100 is a smartphone or a tablet computer.

In one embodiment the virtual display arrangement 100 is an optical see-through device. According to one aspect there is provided a method for providing a virtual display using a virtual display arrangement 100 comprising an optical device, wherein the method comprises: a) detecting an optical pattern 210 through the optical device, the optical pattern 210 being associated with a virtual display and the optical pattern 210 being arranged on an arbitrary surface; b) extracting information regarding the associated virtual display; c) setting up the virtual display to correspond to an area of a display according to the extracted information associated with the optical pattern; d) retrieving virtual content; and to e) presenting the virtual content in the area of the display corresponding to the virtual display.

According to one aspect there is provided a computer-readable medium carrying computer instructions that when loaded into and executed by a controller of a virtual display arrangement 100 enables the viewing device to implement a method according to herein.

According to one aspect there is provided a software component arrangement for providing a virtual display using a virtual display arrangement 100 comprising an optical device, wherein the software component arrangement comprises: a) a software component for detecting an optical pattern 210 through the optical device, the optical pattern 210 being associated with a virtual display; b) a software component for extracting information regarding the associated virtual display; c) a software component for setting up the virtual display to correspond to an area of a display according to the extracted information associated with the optical pattern; d) a software component for retrieving virtual content; and e) a software component for presenting the virtual content in the area of the display corresponding to the virtual display.

According to one aspect there is provided a virtual display arrangement 100 comprising an optical device and comprising circuitry providing a virtual display, the virtual display arrangement 100 further comprising: a) circuitry for detecting an optical pattern 210 through the optical device, the optical pattern 210 being associated with a virtual display and the optical pattern 210 being arranged on an arbitrary surface; b) circuitry for extracting information regarding the associated virtual display; c) circuitry for setting up the virtual display to correspond to an area of a display according to the extracted information associated with the optical pattern; d) circuitry for retrieving virtual content; and e) circuitry for presenting the virtual content in the area of the display corresponding to the virtual display.

The aspects provided herein are beneficial in that they mitigate or overcome the limitations of today's technologies relating to how to synchronize the availability of a virtual display at certain places among several see-through (or other) devices. It also provides a format for how to signal to the virtual display device the possibility that a virtual display might be available at a certain place. And, this format may be used globally.

The aspects provided herein are beneficial in that they enable devices to uniquely identify a specific surface as a virtual display, other than by a current position being matched to stored locations in a map, and use the specific surface to generate a virtual display on the surface in a way that combines the uniquely defined surface possibly where the virtual content is adapted according to a context and/or to the user.

The aspects provided herein are beneficial in that they enable a virtual display anchored to the real world, so that the virtual display will not move when the user moves its head. On a wall without any feature points it is otherwise very hard to get a stable virtual image as intended by the content planning for the virtual display.

Further embodiments and advantages of the present invention will be given in the detailed description. It should be noted that the teachings herein find use in object detection and virtual display arrangements in many areas of computer vision, including image retrieval, industrial use, robotic vision, augmented reality and video surveillance.

### BRIEF DESCRIPTION OF THE DRAWINGS

Embodiments of the invention will be described in the following, reference being made to the appended drawings which illustrate non-limiting examples of how the inventive concept can be reduced into practice.

FIG. 1A shows a schematic view of a virtual display arrangement 100 according to an embodiment of the present invention;

FIG. 1B shows a schematic view of a virtual display arrangement 100 according to an embodiment of the present invention;

FIG. 1C shows a schematic view of a virtual display arrangement 100 according to an embodiment of the present invention;

FIG. 2 shows a schematic view of a virtual display system according to one embodiment of the teachings herein;

FIG. 3A show one example embodiment of how to define a virtual display using an optical pattern 210 according to one embodiment of the teachings herein;

FIG. 3B show one example embodiment of how to define a virtual display using an optical pattern 210 according to one embodiment of the teachings herein;

FIG. 3C show one example embodiment of how to define a virtual display using an optical pattern 210 according to one embodiment of the teachings herein;

FIG. 3D show one example embodiment of how to define a virtual display using an optical pattern 210 according to one embodiment of the teachings herein;

FIG. 4 shows a schematic view of a virtual display system according to one embodiment of the teachings herein;

FIG. 5 shows a flowchart of a general method according to one embodiment of the teachings herein;

FIG. 6 shows a component view for a software component arrangement according to an embodiment of the teachings herein;

FIG. 7 shows a component view for an arrangement comprising circuits according to an embodiment of the teachings herein; and

FIG. 8 shows a schematic view of a computer-readable medium carrying computer instructions that when loaded into and executed by a controller of an arrangement enables the arrangement to implement one embodiment of the teachings herein.

### DETAILED DESCRIPTION

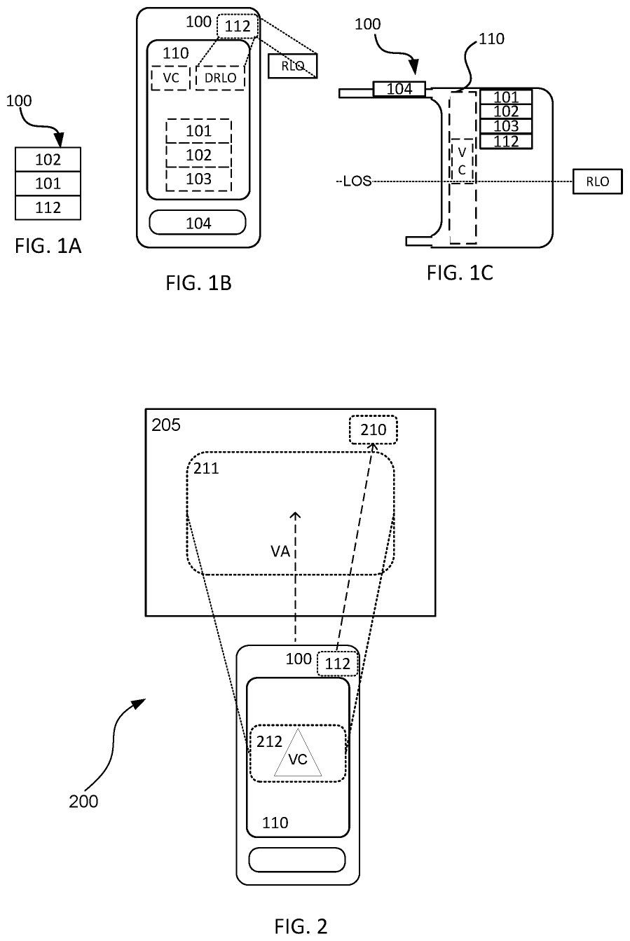

FIG. 1A shows a schematic view of a virtual display arrangement 100 according to an embodiment of the present invention. The virtual display arrangement 100 comprises or is operably connected to a controller 101 and a memory 102. The virtual display arrangement 100 also comprises an optical device, such as for example an image capturing device 112 (such as a camera or image sensor) capable of detecting an optical pattern 210 through receiving light (for example visual, ultraviolet or infrared to mention a few examples), possibly in cooperation with the controller 101. The optical device 112, possibly in combination with the controller 101 is thus configured to receive the light captured by the optical device 112, and detect an optical pattern 210 114 therein. The optical device 112 may be comprised in the virtual display arrangement 100 by being housed in a same housing as the virtual display arrangement, or by being operably connected to it, by a wired connection or wirelessly.

It should be noted that the virtual display arrangement 100 may comprise a single device or may be distributed across several devices and apparatuses.

The controller 101 is also configured to control the overall operation of the virtual display arrangement 100. In one embodiment, the controller 101 is a graphics controller. In one embodiment, the controller 101 is a general purpose controller. In one embodiment, the controller 101 is a combination of a graphics controller and a general purpose controller. As a skilled person would understand there are many alternatives for how to implement a controller, such as using Field-Programmable Gate Arrays circuits, AISIC, GPU, etc. in addition or as an alternative. For the purpose of this application, all such possibilities and alternatives will be referred to simply as the controller 101.

It should also be noted that in one embodiment, parts of or all of the processing is performed remotely, where a local controller 101 is configured to provide input data to a remote processing unit, such as in a cloud server, causing the remote processing unit to perform the processing and receiving the results of such processing as output from the remote processing unit. For the purpose of this application, such possibilities and alternatives will also be referred to simply as the controller 101, the controller thus representing both the local controller and the remote processing unit.

The memory 102 is configured to store graphics data and computer-readable instructions that when loaded into the controller 101 indicates how the virtual display arrangement 100 is to be controlled. The memory 102 may comprise several memory units or devices, but they will be perceived as being part of the same overall memory 102. There may be one memory unit for a display arrangement storing graphics data, one memory unit for optical device storing settings, one memory for the communication interface (see below) for storing settings, and so on. As a skilled person would understand there are many possibilities of how to select where data should be stored and a general memory 102 for the virtual display arrangement 100 is therefore seen to comprise any and all such memory units for the purpose of this application. As a skilled person would understand there are many alternatives of how to implement a memory, for example using non-volatile memory circuits, such as EEPROM memory circuits, or using volatile memory circuits, such as RAM memory circuits. For the purpose of this application all such alternatives will be referred to simply as the memory 102.

It should be noted that the teachings herein find use in virtual display arrangements in many areas of displaying content such as branding, marketing, merchandising, education, information, entertainment, gaming and so on.

FIG. 1B shows a schematic view of a virtual display arrangement 100 being a viewing device 100 according to an embodiment of the present invention. In this embodiment, the viewing device 100 is a smartphone or a tablet computer, being examples of VST devices. In such an embodiment, the viewing device further comprises a (physical) display arrangement 110, which may be a touchscreen, and the optical device 112 may be a camera of the smartphone or tablet computer. In such an embodiment the controller 101 is configured to receive an image from the camera 112 and possibly display the image on the display arrangement 110 along with virtual content VC. In the example embodiment of FIG. 1B, the camera 112 is arranged on a backside (opposite side of the display 110, as is indicated by the dotted contour of the cameras 112) of the virtual display arrangement 100 for enabling real life objects (indicated RLO in FIG. 1B) behind the virtual display arrangement 100 to be captured and shown to a user (as a displayed RLO DRLO as indicted by the dotted lines from the RLO, through the camera to the DRLO on the display 110) on the display 110 along with any virtual content to be displayed. The displayed virtual content may be information and/or graphics indicating and/or giving information.

FIG. 1C shows a schematic view of a virtual display arrangement 100 being an optical see-through (OST) viewing device 100 according to an embodiment of the present invention. The viewing device 100 is an optical see-through device, where a user looks in through one end, and sees the real-life objects (RLO) in the line of sight (LOS) at the other end of the viewing device 100.

In one embodiment the viewing device 100 is a head-mounted viewing device 100 to be worn by a user (not shown explicitly in FIG. 1C) for looking through the viewing device 100. In one such embodiment the viewing device 100 is arranged as glasses, or other eye wear including goggles, to be worn by a user.

The viewing device 100 is in one embodiment arranged to be hand-held, whereby a user can hold up the viewing device 100 to look through it.

The viewing device 100 is in one embodiment arranged to be mounted on for example a tripod, whereby a user can mount the viewing device 100 in a convenient arrangement for looking through it. In one such embodiment, the viewing device 100 may be mounted on a dashboard or in a side-window of a car or other vehicle.

The viewing device comprises a display arrangement 110 for presenting virtual content VC to a viewer, whereby virtual content VC may be displayed to supplement the real-life view being viewed in line of sight.

In the following, simultaneous reference will be made to the virtual display arrangements 100 of FIGS. 1A, 1B and 1C.

It should also be noted that even if only one optical device 112 is discussed in the above and mainly for the purpose of detecting an optical pattern 210, the optical device may be arranged for many other purposes as would be understood by a skilled person even if such purposes are not discussed herein, such as operating as a camera, biometric sensor or other uses for optical sensors.

In one embodiment the virtual display arrangement 100 may further comprise a communication interface 103. The communication interface 103 may be wired and/or wireless. The communication interface 103 may comprise several interfaces.

In one embodiment the communication interface 103 comprises a USB (Universal Serial Bus) interface. In one embodiment the communication interface 103 comprises a HDMI (High Definition Multimedia Interface) interface. In one embodiment the communication interface 103 comprises a Display Port interface. In one embodiment the communication interface 103 comprises an Ethernet interface. In one embodiment the communication interface 103 comprises a MIPI (Mobile Industry Processor Interface) interface. In one embodiment the communication interface 103 comprises an analog interface, a CAN (Controller Area Network) bus interface, an I2C (Inter-Integrated Circuit) interface, or other interface.

In one embodiment the communication interface 103 comprises a radio frequency (RF) communication interface. In one such embodiment the communication interface 103 comprises a Bluetooth™ interface, a WiFi™ interface, a ZigBee™ interface, a RFID™ (Radio Frequency IDentifier) interface, Wireless Display (WiDi) interface, Miracast interface, and/or other RF interface commonly used for short range RF communication. In an alternative or supplemental such embodiment the communication interface 103 comprises a cellular communication interface such as a fifth generation (5G) cellular communication interface 103, an LTE (Long Term Evolution) interface, a GSM (Global Systeme Mobile) interface and/or other interface commonly used for cellular communication. In one embodiment the communication interface is configured to communicate using the UPnP (Universal Plug n Play) protocol. In one embodiment the communication interface is configured to communicate using the DLNA (Digital Living Network Appliance) protocol. Would be apparent to a skilled person that other standards and protocols are also possible and the teachings herein is not dependent on any specific standard or protocol.

In one embodiment, the communication interface 103 is configured to enable communication through more than one of the example technologies given above. As an example, a wired interface, such as MIPI could be used for establishing an interface between the display arrangement, the controller and the user interface, and a wireless interface, for example WiFi™ could be used to enable communication between the virtual display arrangement 100 and an external host device (not shown).

The communication interface 103 may be configured to enable the virtual display arrangement 100 to communicate with other devices, such as other virtual display arrangements 100 and/or smartphones, Internet tablets, computer tablets or other computers, media devices, such as television sets, gaming consoles, video viewers or projectors (not shown), or image capturing devices for receiving the image data streams.

A user interface 104 may be comprised in the virtual display arrangement 100 (only shown in FIGS. 1B and 1C). Additionally or alternatively, (at least a part of) the user interface 104 may be comprised remotely in the virtual display arrangement 100 through the communication interface 103, the user interface then (at least a part of it) not being a physical means in the virtual display arrangement 100, but implemented by receiving user input through a remote device (not shown) through the communication interface 103. One example of such a remote device is a game controller, a mobile phone handset, a tablet computer or a computer.

FIG. 2 shows a schematic view of virtual display system 200 according to the teachings herein. The virtual display system comprises a virtual display arrangement 100 according to any of the embodiments disclosed above and herein. In the example view of FIG. 2, the virtual display arrangement 100 is aimed or directed at an arbitrary or general surface 205 on which an optical pattern 210 is arranged. The arbitrary surface 205 may be any surface including walls, and other building structures, as well as cars, and other vehicles, clothes, accessories such as bags, including dedicated advertisement structures, such as billboards. The arbitrary surface may thus be any surface that is otherwise unrecognizable as it may be without specific features, or with features that are not uniquely identifiable. The arbitrary surface may also be a surface that is not associated with or related to the virtual content in any manner.

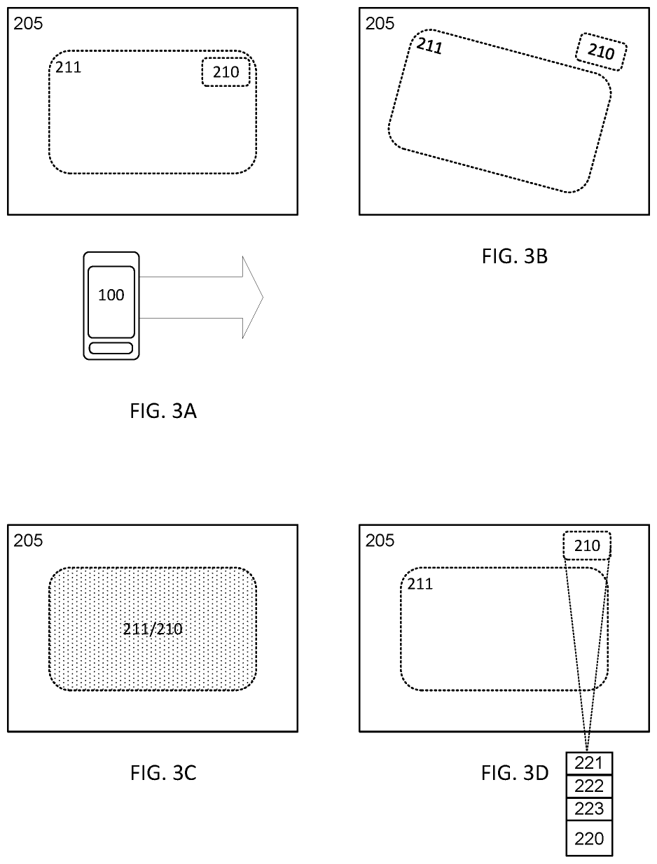

The optical pattern 210 may be arranged in a plurality of different manners (as will also be discussed in relation to FIGS. 3A, 3B, 3C and 3D), but main embodiments are that the optical pattern 210 is painted or drawn on the surface (both being examples of applying the optical pattern 210 by paint), embossed in the surface, part of a sticker attached to the surface 205 or even projected onto the surface 205 (as will be discussed in relation to FIG. 3D). Examples of optical patterns 210 that may be used are bar codes for example QR codes, dotted structures, such as ADNA® by Anoto™, company logos or any detectable optical pattern 210. The optical pattern 210 is in a visible spectra in one embodiment, in a non-visible spectra in one embodiment, and in both a visible spectra and a non-visible spectra in one embodiment.

The optical pattern 210 is associated with a virtual display 211 on which virtual content VC may be displayed by a virtual display arrangement 100. The virtual display arrangement 100 is configured to, utilizing the optical device 112, detect the optical pattern 210 being associated with the virtual display 211 and to display the virtual content VC on the virtual display 211. In one embodiment, the virtual content is displayed according to the current viewing angle (referenced VA in FIG. 2) to the virtual display, as if the virtual content was part of the virtual display, same as in a physical display.

In one embodiment, the optical pattern 210 is arranged remote from the virtual display 211. FIG. 2, FIG. 3B and FIG. 3D show examples where the optical pattern 210 is arranged adjacent the virtual display 211. It should be noted that the optical pattern 210 may not be arranged adjacent the virtual display 211, but may even be arranged on a different surface. In one embodiment, the optical pattern 210 is arranged as being a part of or inside the virtual display 211. FIG. 3A and FIG. 3C shows examples where the optical pattern 210 is arranged inside the virtual display 211 (FIG. 3A) and where the optical pattern 210 is arranged as a part of the virtual display 211 (FIG. 3C). It should be noted that the optical pattern 210 may not be arranged adjacent the virtual display 211, but may even be arranged on a different surface.

FIG. 3A shows a schematic view of a surface 205 and an optical pattern 210 and an associated virtual display 211. As stated above, the optical pattern 210 may be applied to the surface 205 in many different manners and be used to indicate an intended position/extent of the associated virtual display 211 in relation to the optical pattern 210. The optical pattern 210 may be arranged to operate as an anchor for the virtual display 211, so that even if a virtual display arrangement 100 is moved, the virtual display 211 remains fixed with relation to the optical pattern 210. This is illustrated by the virtual display arrangement 100 being shown with an arrow indicating a movement, while no such arrow is indicated for the virtual display 211. This enables the pattern to act as an anchor point for the image, i.e. virtual content, keeping it in the correct position independent of the movement of the user.

FIG. 3B shows a schematic view of a surface 205 and an optical pattern 210 and an associated virtual display 211. In this view, the optical pattern 210 is skewed or rotated in relation to the optical pattern 210 of FIG. 3A. As is also shown, the optical pattern 210 may have an orientation so that as the optical pattern 210 is rotated or applied at an angle, the associated virtual display 211 will also be rotated or presented at the same angle.

It should be noted that the optical pattern 210 in itself may have a rotational or skewed aspect, wherein the virtual display 211 may still be arranged vertically. The rotation is then considered as a part of the optical pattern 210.

Alternatively, the optical pattern 210 is associated with information on the angle to present the virtual display at 211. This enables for arranging the virtual display 211 at any desired angle without having to apply the optical pattern 210 at such angle as this may be difficult during fast mounting. The angle may be a viewing angle VA.

FIG. 3C shows a schematic view of a surface 205 and an optical pattern 210 and an associated virtual display 211. In this view, the optical pattern 210 defines the virtual display 211, and the optical pattern 210 will function as the virtual display 211. As the controller of a virtual display arrangement 100 detects or recognizes the optical pattern 210 it will determine the extent of the optical pattern 210 and use the optical pattern 210 as a virtual display 211. In this manner a virtual display 211 may be achieved by providing a surface that is different from the surrounding surfaces, perhaps in a manner that is naked to the eye. One example being providing a different structure—for example a dotted area. Another example is to paint an area in a color that is not visible to the naked eye, but is detectable to the optical device 112.

FIG. 3D shows a schematic view of a surface 205 and an optical pattern 210 and an associated virtual display 211. In this view, the optical pattern 210 is provided by a projecting device 220. The projecting device 220 comprises a projector 221 arranged to optically project the optical pattern 210 on to a surface 205, which optical pattern 210 may be detected by an optical device 112 thereby defining a virtual display 211. The projecting device 220 may comprise a controller 222 for controlling the operation of the projecting device 220, and a memory 223 for storing settings, instructions and data regarding the optical pattern 210 210 that may be read by the controller 222 during operation of the projecting device 220. This enables the projecting device 220 to project different or changing optical patterns 210. Alternatively, the projecting device 220 is not a smart device and is only set to project one type of optical pattern 210 that is hardcoded into the projecting device 220 possibly through the use of a mask. One embodiment is a bi-stable display, such as electronic ink (E-ink) or Mirasol™ to mention a few examples that can be used as a mask. Such displays are able to display the same image without using any power. Such displays can also be updated, thus being somewhere between a smart device and a static device. The projecting device 220 may be comprises in another device, such as a virtual display arrangement 100. In such an embodiment the projecting device may then share a controller and a memory with the comprising device. Examples of projecting devices are laser pointers, visual light projectors, Infrared projectors, ultraviolet projectors to mention a few examples.

The optical pattern 210 could be either globally uniquely defined (such as the aDNA® developed by Anoto™), or could be unique for a certain geographical area (for fixed locations) and then separable by using the position of the virtual display arrangement 100. Then the virtual display 211 becomes globally unique through the combination of local uniqueness plus a position, and the position need not be extremely accurate—as in the prior art.

FIGS. 3A, 3B, 3C and 3D show some examples of how to define a virtual display 211 using an optical pattern 210. Other examples include to have personal unique areas on clothes where the AR/MR headset might show a virtual display 211 similar to a personal watch, without having to actually have the watch-display integrated into the clothes. The relation between the uniquely patterned area and the identity of the user and/or see-through device enables that virtual display to be only visible by the user and no else. Or would allow anyone to see a certain content but the owner something else. The visual pattern could be tattooed on a body part.

As stated above with relation to FIG. 2, the virtual display arrangement 100 is configured to detect an optical pattern 210 indicating a virtual display 211 and display associated virtual content VC on the virtual display 211. To enable this, the optical pattern 210 is associated with display properties, which properties may indicate the location of the virtual display 211 (absolute or relative the optical pattern 210), a size of the virtual display 211, a resolution of the virtual display 211, a color-scheme of the virtual display 211, or other display properties.

To enable this, the optical pattern 210 is alternatively or additionally associated with content parameters, which content parameters may indicate which virtual content should be displayed on the corresponding virtual display 211. These content parameters may be related to information regarding the user of the virtual display arrangement 100 so that different content will possibly be displayed for different users depending on the content parameters and the users. Examples of information regarding a user may relate to personal preferences, internet usage, search history, age, sex, occupation, indicated interests, or other factors that may affect what content should be displayed. These content parameters may additionally or alternatively be related to a context so that different content will possibly be displayed to the same user but being in different contexts. Examples of contexts, may relate to recent search history, actively or recently viewed content, time of day, number of times using the virtual display 211, or other factors that may affect what content should be displayed.

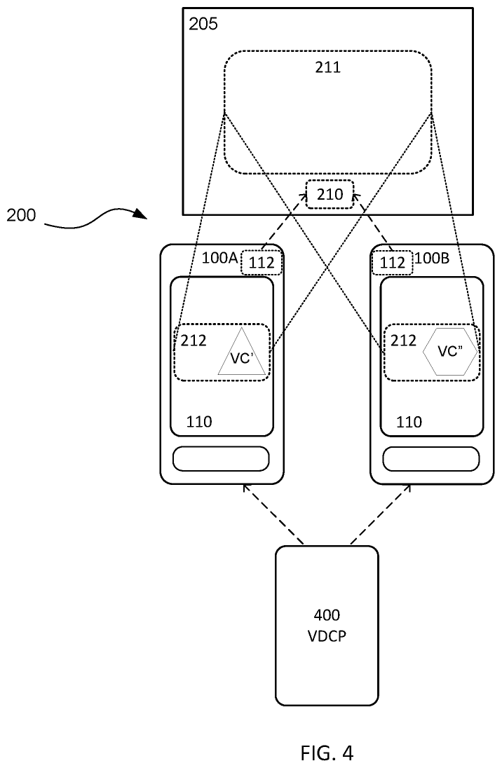

FIG. 4 shows a schematic view of a virtual display system 200 comprising a first virtual display arrangement 100A and a second virtual display arrangement 100B. Both the first virtual display arrangement 100A and the second virtual display arrangement 100B may be any type of virtual display arrangement 100 as disclosed herein. Both the first virtual display arrangement 100A and the second virtual display arrangement 100B are directed at a surface 205. On this surface an optical pattern 210 is arranged, possibly in a manner as discussed above. The optical device 112 of the first virtual display arrangement 100A detects the optical pattern 210 and retrieves the properties and content associated with the optical pattern 210, resulting in that the first virtual display arrangement 100A displays a first virtual content VC′ on a display 110 of the first virtual display arrangement 100A in a display area 212 that corresponds to the virtual display 211 as defined by the associations of the optical pattern 210. Similarly, the optical device 112 of the second virtual display arrangement 100B detects the optical pattern 210 and retrieves the properties and content associated with the optical pattern 210, resulting in that the second virtual display arrangement 100B displays a second virtual content VC″ on a display 110 of the first virtual display arrangement 100A in a display area 212 that corresponds to the virtual display 211 as defined by the associations of the optical pattern 210. It could be noted that the display areas will display the virtual display 211 as it being in the same location on the surface 205. The user of the first virtual display arrangement 100A and the user of the second virtual display arrangement 100B are thus viewing the same virtual display 100B in the same location regardless of their respective movements. However, depending on the users, their contexts and the context in general, the user of the first virtual display arrangement 100A and the user of the second virtual display arrangement 100B may not be viewing the same virtual content VC, as the content may be user-specific and/or depend on a context. In the example of FIG. 4, the user of the first virtual display arrangement 100A is viewing the first virtual content VC′ and the user of the second virtual display arrangement 100B viewing the second virtual content VC″, which virtual contents are illustrated as not being the same (the first virtual content VC′ being illustrated as a triangle and the second virtual content VC″ being illustrated as a hexagon).

Exactly how the content is selected for a user would be known to persons skilled in the art of providing content, but this is outside the scope of the teachings, and it suffices to say that there are many alternatives for how to do so. Some alternatives include to get the unique identity of the display only through its visual pattern, and let the content shown be unique for that display. Different people can see different content of the same display. i.e. on a billboard, the advertisement could depend on a person's preferences or be personal in other ways. A person might be able to see certain content if he/she has certain memberships. A person can be exposed to less advertisement if he/she has certain membership. It is also possible to communicate unique messages to individual people to be visible on areas in e.g. a city that would be visible when the person is there and looks at that surface.

FIG. 4 also shows that the system 200 may comprise a virtual display content provider (VDCP) server 400. The VDCP 400 is a server that the virtual display arrangement 100 communicates with upon detecting an optical pattern 210 to retrieve the virtual content to be displayed, and possibly in part to retrieve display properties. In one embodiment the VDCP 400 is a remote server that the virtual display arrangement 100 communicates with through the communication interface 103. In one embodiment the VDCP 400 is a local server that the virtual display arrangement 100 communicates with through the memory 102. In FIG. 2, the VDCP 400 is assumed to be a local server and hence not specifically indicated, and in FIG. 4, the VDCP 400 is assumed to be a remote server and hence specifically indicated. It should be noted that the VDCP 400 may also or alternatively be a combination of remote serer and a local server, where some properties and/or content are stored locally and some properties and/or content are stored remotely.

The VDCP 400 could be provided by a third party company that supply the content for a virtual display. Alternatively, the user could provide the content to the user's own personal devices and define walls in the home for virtual display content or on clothing, skin etc.

To maintain integrity and security the virtual display arrangement 100 could be arranged with security measures for communicating with the VDCP 400. For any new virtual display 211 and/or new VDCP 400 or combination thereof, the virtual display arrangement 100 is configured to prompt a security question asking if the user can trust the specific virtual display and/or VDCP. This is similar to when installing applications on contemporary devices such as smartphones or other mobile handsets. This enables the user to accept a specific display or a specific VDCP 400 which would enable some or all of the virtual displays provided by that VDCP.

For content belonging to the personal area network or private area (virtual displays on clothes, body parts, in the home, etc.), the content might be stored or generated in, and controlled by, the host system. That means that the VDCP 400 might be the virtual display arrangement 100, or apps in a device in the user's personal network, or a third-party company as described above.

Furthermore, in some embodiments, the connection between the virtual content and the identity of the user must be trusted, private, and/or secure. That would imply signatures, encrypted traffic, and authentication as is known to persons skilled in the art of security. Exactly how such security measures are implemented is outside the scope of the present teachings and it suffices to state that many alternatives exist.

The association(s) above may fully or partially be indicated as part of a coding of the optical pattern 210, whereby the coding of the optical pattern 210 provides the information necessary for enabling the virtual display arrangement 100 to implement the association. The controller 101 of the virtual display arrangement 100 is thus configured to decode the optical pattern 210 and based on the decoding implement the association. For example, the optical pattern 210 may comprise a coding that when decoded provides relative coordinates and extent for the virtual display 211.

Alternatively or additionally the association(s) above may fully or partially be retrieved through a link to a remote storage, the link possibly being part of the coding of the optical pattern 210. The controller 101 of the virtual display arrangement 100 is thus configured to decode the optical pattern 210 and based on the decoding identify a link (or other address) and retrieve needed data from a remote memory storage accessible through the link to implement the association. For example, the optical pattern 210 may comprise a coding that when decoded provides a link to a server that when queried provides relative coordinates and extent for the virtual display 211 and which virtual content VC that should be displayed. By having a remote storage, the VDCP 400 and the associated information is easily updated and can be altered at any time to be adjusted if the scene is changed. One example would be that there are different requirements for day and night settings for the virtual display. Another example could be that the wall is repainted, and a different background color is applied, and the color correction matrix need to be updated so that the content will look good (like it did before the change).

Alternatively or additionally the association(s) above may fully or partially be retrieved through an identifier of the optical pattern 210. The identifier may be part of a coding of the optical pattern 210. Alternatively or additionally, the identifier may be the optical pattern 210 itself, for example as when the optical pattern 210 is a logo or other trademark. The identifier may be correspond to a set of associations, which may be retrieved from a memory storage, internal or external, such as by querying a (know) server associated with the identifier. The controller 101 of the virtual display arrangement 100 is thus configured to retrieve an identifier from the optical pattern 210 and retrieve needed data from a (remote) memory storage corresponding to the identifier link to implement the association. For example, the optical pattern 210 may be a known company logo that corresponds to a company server that when queried provides relative coordinates and extent for the virtual display 211 and which virtual content VC that should be displayed. Alternatively, an optical pattern 210 identity may have default settings and associations stored in the memory 102 (or remotely) that the virtual display arrangement 100 can retrieve swiftly.

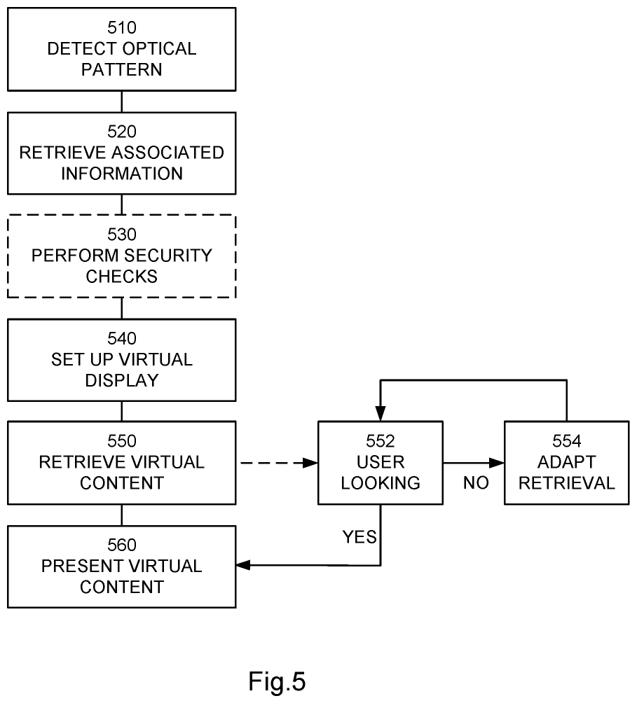

FIG. 5 shows a flowchart of a general method according to an embodiment of the teachings herein. The method utilizes a virtual display arrangement 100 as taught herein. In one embodiment, the virtual display arrangement 100 is configured to provide a virtual display by detecting an optical pattern 210 associated with the virtual display. Details on how this may be done has been given above with reference to FIGS. 2, 3A, 3B, 3C, 3D and 4, and will be supplemented below with simultaneous reference to FIGS. 2, 3A, 3B, 3C, 3D, 4 and 5.

The virtual display arrangement 100 is thus configured to detect 510 an optical pattern 210. Depending on the system there could be an optical device 112 such as a camera, that is always on and will detect the different types of objects and one of the objects could be the optical pattern 210. There could also be the case that the user manually needs to turn on the system to be able to look at the virtual display content.

The optical pattern 210 is associated with information regarding a virtual display 211 and the virtual display arrangement 100 retrieves 520 the associated information in a manner as disclosed above from a remote storage and/or from a local storage—or possibly (as discussed above) through a coding of the optical pattern 210.

The virtual display arrangement 100 is, in one embodiment, (alternatively as indicated by dashed box) configured to perform security checks 530 to determine if the virtual display and/or the associated VDCP 400 is one that has not been used before and if so determine if the user trusts the virtual display and/or the VDCP. The virtual display arrangement 100 may determine if the virtual display and/or the associated VDCP 400 is one that has not been used before by comparing an identifier for the optical pattern 210 and/or for the VDCP 400 with a local storage of previously trusted VDCPs and virtual displays; a whitelist, or alternatively (or additionally) the opposite, a blacklist of not trusted VDCPs. For example, if a new VDCP 400 is detected, the virtual display arrangement 100 could prompt a security question asking if the VDCP 400 is trusted or not. If the user accepts the VDCP 400 it will be whitelisted, if it is rejected it will be blacklisted. The lists can later manually be altered if the user need or want to do changes to the previous decisions. In some embodiments, the user must explicitly accept (pressing button, verbal input, or any other explicit approval), and this can be done per VDCP 400 or other granularity. In some embodiments, such approvals can be automatic for some types of contents depending on settings, profile, context, or others.

As a VDCP 400 is accepted, the virtual display arrangement 100 sets up 540 the virtual display 211 by retrieving the associated information regarding display properties. Examples of properties that can be setup is: Size of the virtual display, Position of the virtual display, Resolution of the virtual display, Color calibration specification, e.g. color gamut such as sRGB, Adobe RGB etc., color point specifications, luminance, and Refresh-rate of the virtual display to mention a few examples.

In some instances, the setup procedure will adapt the setting based on what capabilities the virtual display arrangement 100 has. In some cases, the virtual display arrangement 100 that is going to show the virtual display will set the limit of what it can visualize.

As the virtual display 211 is set up, the virtual display arrangement 100 initiates retrieving 550 the virtual content VC. The virtual content may be selected in many different manners as discussed above and may be different depending on the user, a context of the user (also being dependent on the user) and/or a general context.

In order to reduce bandwidth, the virtual display arrangement 100 is, in one embodiment, (alternatively as indicated by dashed arrow) configured to determine 552 whether the virtual display arrangement 100 or the user of the virtual display arrangement 100 is actually facing the surface 205 and/or is able to actually see the virtual display 211. In such an embodiment, the virtual display arrangement 100 is configured to determine that the virtual display arrangement 100 and/or the user is actually looking at the area of the virtual display. If the virtual display arrangement 100 and/or the user is not looking in the direction of the virtual display 211, the virtual display arrangement 100 should not download any content, or just limited resolution to have a quick transition from previous frame that was shown to the new content. The virtual display arrangement 100 may thus be configured in one embodiment to adapt 554, such as stop, pause or reduce, the retrieval (download or memory reading) of content when it is determined that the virtual display arrangement 100 and/or the user is not facing the surface 205 or rather the virtual display 211. In one such embodiment, the virtual display arrangement 100 is configured to stop visual content, but keep downloading audio content to accompany the visual content. This enables for a continuity of the content while reducing the needed bandwidth. The virtual display arrangement 100 may also be configured to detect that the virtual display arrangement 100 and/or the user is facing the virtual display 211 again and to start downloading the content from VDCP 400 to the virtual display arrangement 100 again and the virtual content will be shown on as specified by the optical pattern 210. In such an embodiment, the content stream stops from the VDCP 400 when the user looks away from the virtual display 211, and it is resumed again when the user is moving the gaze back to the virtual display 211.

As the virtual content is retrieved, the virtual display arrangement 100 is arranged to present 560 the virtual content in an area 212 of a display 110 of (comprised within or connected to) the virtual display arrangement 100 corresponding to the virtual display 211 as specified by associations of the optical pattern 210, the virtual content thus being presented as if on the virtual display 211 on the surface 205.

In one embodiment the virtual content is visual content enabling images or video streams to be presented to a user through any given surface.

In one embodiment the virtual content is audio content enabling sound such as recordings to be presented to a user through any given surface.

In one embodiment the virtual content is a combination of visual content and audio content enabling images or video streams as well as sound (such as recordings) to be presented to a user through any given surface.

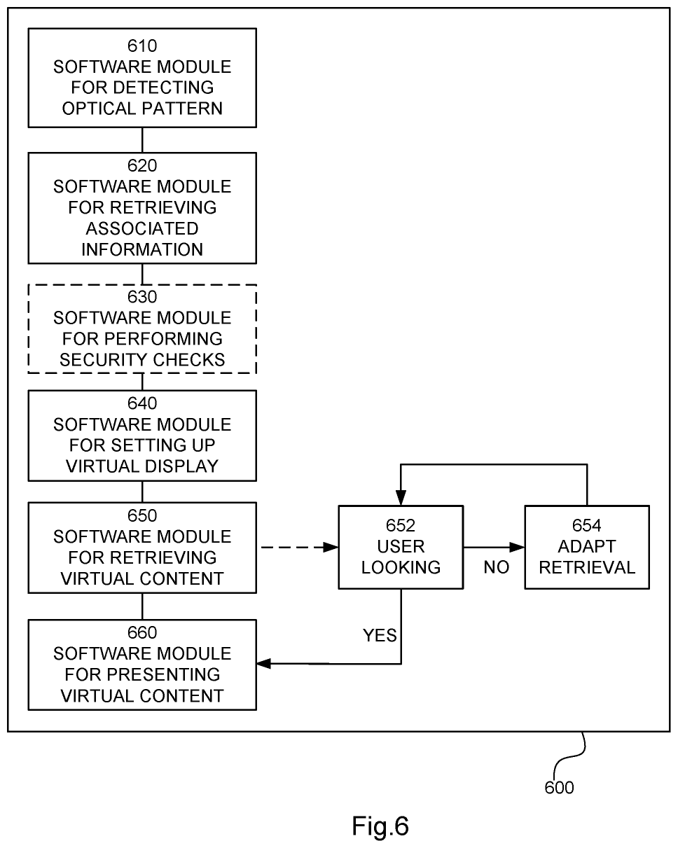

FIG. 6 shows a component view for a software component or module arrangement 600 according to an embodiment of the teachings herein. The software component arrangement 600 is adapted to be used in a virtual display arrangement 100 as taught herein for providing a virtual display as taught herein.

The software component arrangement 600 is arranged for providing a virtual display 211 in a virtual display arrangement 100 comprising an optical device 112, wherein the software component arrangement 600 comprises a software component 610 for detecting 610 an optical pattern 210 through the optical device 210, the optical pattern 210 being associated with a virtual display 211 and a software component for extracting 620 information regarding the associated virtual display 211.

The software component arrangement 600 also comprises a software component for setting up 640 the virtual display 211 to correspond to an area 212 of a display 110 according to the extracted information associated with the optical pattern 210.

The software component arrangement 600 also comprises a software component for retrieving 650 virtual content VC and a software component for presenting 660 the virtual content VC in the area 212 of the display 110 corresponding to the virtual display 211.

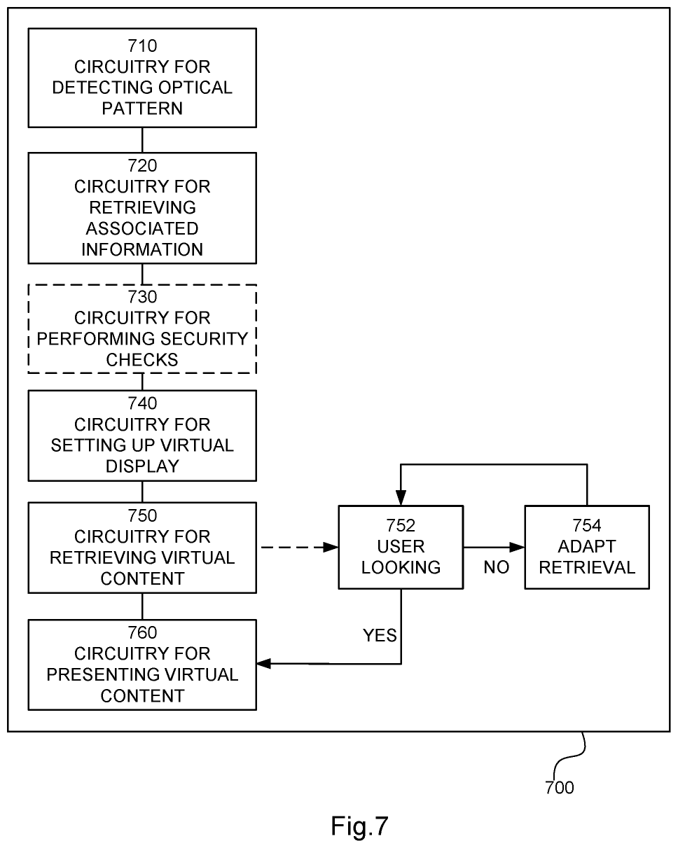

FIG. 7 shows a component view for an arrangement 700 comprising circuitry for providing a virtual display according to an embodiment of the teachings herein. The arrangement comprising circuitry for providing a virtual display detection 700 is adapted to be used in a virtual display arrangement 100 as taught herein for providing a virtual display.

The arrangement 700 for providing a virtual display arrangement 700 for providing a virtual display comprises an optical device 112 and comprises circuitry providing a virtual display 211. The arrangement 700 for providing a virtual display further comprises circuitry for detecting 710 an optical pattern 210 through the optical device 210, the optical pattern 210 being associated with a virtual display 211, and circuitry for extracting 720 information regarding the associated virtual display 211. The arrangement 700 for providing a virtual display further comprises circuitry for setting up 740 the virtual display 211 to correspond to an area 212 of a display 110 according to the extracted information associated with the optical pattern 210.

The arrangement 700 for providing a virtual display further comprises circuitry for retrieving 750 virtual content VC and circuitry for presenting 760 the virtual content VC in the area 212 of the display 110 corresponding to the virtual display 211.

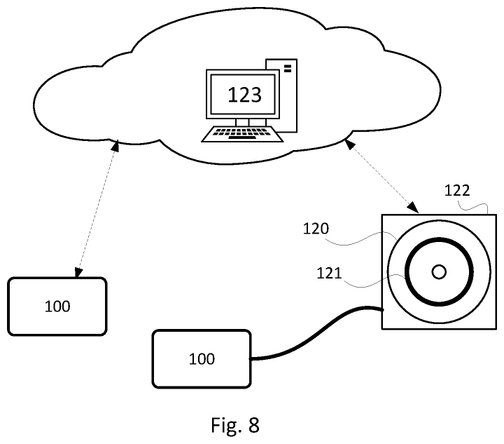

FIG. 8 shows a schematic view of a computer-readable medium 120 carrying computer instructions 121 that when loaded into and executed by a controller of a virtual display arrangement 100 enables the virtual display arrangement 100 to implement the present invention.

The computer-readable medium 120 may be tangible such as a hard drive or a flash memory, for example a USB memory stick or a cloud server. Alternatively, the computer-readable medium 120 may be intangible such as a signal carrying the computer instructions enabling the computer instructions to be downloaded through a network connection, such as an internet connection.

In the example of FIG. 8, a computer-readable medium 120 is shown as being a computer disc 120 carrying computer-readable computer instructions 121, being inserted in a computer disc reader 122. The computer disc reader 122 may be part of a cloud server 123—or other server—or the computer disc reader may be connected to a cloud server 123—or other server. The cloud server 123 may be part of the internet or at least connected to the internet. The cloud server 123 may alternatively be connected through a proprietary or dedicated connection. In one example embodiment, the computer instructions are stored at a remote server 123 and be downloaded to the memory 102 of the virtual display arrangement 100 for being executed by the controller 101.

The computer disc reader 122 may also or alternatively be connected to (or possibly inserted into) a virtual display arrangement 100 for transferring the computer-readable computer instructions 121 to a controller of the virtual display arrangement 100 (presumably via a memory of the virtual display arrangement 100).

FIG. 8 shows both the situation when a virtual display arrangement 100 receives the computer-readable computer instructions 121 via a server connection and the situation when another virtual display arrangement 100 receives the computer-readable computer instructions 121 through a wired interface. This enables for computer-readable computer instructions 121 being downloaded into a virtual display arrangement 100 thereby enabling the virtual display arrangement 100 to operate according to and implement the invention as disclosed herein.

1. A virtual display arrangement comprising an optical device and a controller configured to:
a) detect an optical pattern through the optical device, the optical pattern being associated with a virtual display and the optical pattern being arranged on an arbitrary surface;
b) extract information regarding the associated virtual display;
c) set up the virtual display to correspond to an area of a display; according to the extracted information associated with the optical pattern;
d) retrieve virtual content (VC); and to
e) present the virtual content (VC) in the area of the display corresponding to the virtual display.

2. The virtual display arrangement according to claim 1, wherein the controller is further configured to perform security checks by
f) determining if the optical pattern is associated with a virtual display content provider (VDCP) and
g) determining if the virtual display content provider (VDCP) is trusted.

3. The virtual display arrangement according to claim 1, wherein the controller is further configured to determine if the virtual display arrangement is directed at the virtual display, and if not adapt the retrieval of the virtual content (VC).

4. The virtual display arrangement according to claim 1, wherein the virtual content is dependent on a user of the virtual display arrangement.

5. The virtual display arrangement according to claim 1, wherein the virtual content is dependent on a context.

6. The virtual display arrangement according to claim 1, wherein the optical pattern is applied at least partially in the visible spectra.

7. The virtual display arrangement according to claim 1, wherein the optical pattern is applied at least partially in the non-visible spectra.

8. The virtual display arrangement according to claim 1, wherein the optical pattern is applied to a surface through paint, a sticker, and/or a projection.

9-10. (canceled)

11. The virtual display arrangement according to claim 8, wherein the surface that the optical pattern is applied to is a wall, a piece of garment, or an accessory.

12-13. (canceled)

14. The virtual display arrangement according to claim 1, wherein the optical pattern is associated with a size and a location of the virtual display.

15. The virtual display arrangement according to claim 14, wherein the optical pattern is associated with an angle of the virtual display.

16. The virtual display arrangement according to claim 1, wherein the virtual content (VC) comprises visual content.

17. The virtual display arrangement according to claim 1, wherein the optical pattern is associated with a brand and/or company.

18. The virtual display arrangement according to claim 1, wherein the controller is configured to:
b) extract information regarding the associated virtual display from a remote server.

19. The virtual display arrangement according to claim 1, further comprising a memory arranged to store a local server (VDCP), wherein the controller is configured to:
b) extract information regarding the associated virtual display from the local server in the memory.

20. The virtual display arrangement according to claim 1, wherein the virtual display arrangement is a smartphone or a tablet computer.

21. The virtual display arrangement according to claim 1, wherein the virtual display arrangement is an optical see-through device.

22. A method for providing a virtual display using a virtual display arrangement comprising an optical device, wherein the method comprises:
a) detecting an optical pattern through the optical device, the optical pattern being associated with a virtual display and the optical pattern being arranged on an arbitrary surface;
b) extracting information regarding the associated virtual display;
c) setting up the virtual display to correspond to an area of a display according to the extracted information associated with the optical pattern;
d) retrieving virtual content (VC); and to
e) presenting the virtual content (VC) in the area of the display corresponding to the virtual display.

23. A computer-readable medium carrying computer instructions that when loaded into and executed by a controller of a virtual display arrangement enables the virtual display arrangement to implement the method according to claim 22.

24. (canceled)

25. A virtual display arrangement comprising an optical device and comprising circuitry providing a virtual display, the virtual display arrangement further comprising:
a) circuitry for detecting an optical pattern through the optical device, the optical pattern being associated with a virtual display;
b) circuitry for extracting information regarding the associated virtual display;
c) circuitry for setting up the virtual display to correspond to an area of a display according to the extracted information associated with the optical pattern;
d) circuitry for retrieving virtual content (VC); and
e) circuitry for presenting the virtual content (VC) in the area of the display corresponding to the virtual display.
